(19) United States
(12) Patent Application Publication
(10) Pub. No.: US 2023/0132710 A1
(43) Pub. Date: May 4, 2023

(54) METHOD AND APPARATUS FOR IMPROVED ENTITY EXTRACTION FROM AUDIO CALLS

(71) Applicant: Uniphore Technologies, Inc., Palo Alto, CA (US)

(72) Inventor: Aravind GANAPATHIRAJU, Hyderabad (IN)

(21) Appl. No.: 17/978,195

(22) Filed: Oct. 31, 2022

(30) Foreign Application Priority Data
Oct. 30, 2021 (IN) 202111049851

(51) Int. Cl. G06F 40/295; G10L 15/16; G10L 15/30; G10L 15/22; G10L 15/06; G06F 40/166; G10L 15/18; H04M 3/22

(52) U.S. Cl. CPC G06F 40/295; G10L 15/16; G10L 15/30; G10L 15/22; G10L 15/063; G06F 40/166; G10L 15/18; H04M 3/22

(57) ABSTRACT

In a method and apparatus for improved entity extraction in an audio of a conversation or a call, the method includes generating, at a server, from speech data of a conversation between at least two persons, text data and associated preliminary entity prediction data, using an automated speech recognition (ASR) engine comprising one or more neural networks trained via multi-task training. The method further includes identifying, using the text data and associated preliminary entity prediction data, at least one named entity in said speech data.

### CROSS-REFERENCE TO RELATED APPLICATIONS

This application claims the benefit of the Indian Provisional Patent Application No. 202111049851, filed on Oct. 30, 2021, incorporated by reference herein in its entirety.

### FIELD

The present invention relates generally to speech audio processing, and particularly to an improved entity extraction from audio of a conversation or a call in customer service environments.

### BACKGROUND

Several businesses need to provide support to its customers, which is provided by a customer service center (also known as a “call center”) operated by or on behalf of the businesses. Customers of a business place an audio or a multimedia call to, or initiate a chat with, the call center of the business, where customer service agents address and resolve customer issues, to address the customer's queries, requests, issues and the like. The agent uses a computerized management system used for managing and processing interactions or conversations (e.g., calls, chats and the like) between the agent and the customer. The agent is expected to understand the customer's issues, provide appropriate resolution, and achieve customer satisfaction.

Customer service management systems (or call center management systems) may help with an agent's workload, complement or supplement an agent's functions, manage agent's performance, or manage customer satisfaction, and in general, such call management systems can benefit from understanding the content of a conversation, such as entities mentioned, intent of the customer, among other information. Such systems may rely on automated identification of intent and/or entities of the customer (e.g., in a call or a chat). Conventional systems, which typically rely on an artificial intelligence and/or machine learning (AI/ML) model, for example, to classify the call or a chat into an intent classification, often suffer from low accuracy. Most modern conversational AIs work in two steps. First, automated speech recognition (ASR) techniques are used to convert speech data (spoken words) into transcripts comprising sequences of words. Currently used ASR systems often rely on next-word predictions from a history of words hypothesized from the previously extracted words. This may include n-gram models wherein n-grams are used to predict the occurrence of a word based on the occurrence of the n−1 previous words (e.g., the history).

Second, the transcripts are analyzed using natural language processing (NLP) methods or the like to extract related macro information. The related macro information may include, among other things, entity data. The entity data may include, for example, names, numbers, organizations, dates, money, alphanumeric, of like elements disclosed in the transcripts.

However, the entity extraction step may be very resource intensive as some words, for examples numbers, could belong to many entities depending on the context. For example, the sequence of words “one two three” could belong to several entities such as LOCATION, CVV, QUANTITY, CURRENCY, and the like.

Accordingly, there exists a need in the art for a method and apparatus for an improved entity extraction in customer service environments.

### SUMMARY

The present invention provides a method and an apparatus for an improved entity extraction from audio of a conversation or a call in customer service environments, substantially as shown in and/or described in connection with at least one of the figures, as set forth more completely in the claims. These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic depicting an apparatus for improved entity extraction from an audio in call center environments, in accordance with an embodiment.

FIG. 2 illustrates a method for improved entity extraction from an audio, performed by the apparatus of FIG. 1, in accordance with an embodiment.

### DETAILED DESCRIPTION

Embodiments of the present invention relate to a method and an apparatus for an improved entity extraction from an audio of a conversation or a call in call center environments, for example, in a call between a customer and an agent. In embodiments disclosed herein, an ASR Engine is configured via a process of multi-task training, thereby rendering it operable to generate from input speech data simultaneously both text data and associated preliminary entity prediction data, which when used by a named entity recognition module or the like improves the performance thereof.

ASR systems are context-sensitive by construction and may be used to improve the entity extraction or identification of speech data. It is theorized that one entity type from another is differentiated by the context in which entities, for example, a number sequence “one two three” is used. If the word “CVV” is identified in the context of the sequence “one two three,” there is a higher probability that the number sequence is a CVV entity. Similarly, if the words “address”, “live”, and the like are identified instead, then the sequence “one two three” would probably belong to a LOCATION entity.

The method and apparatus described below, in accordance with different embodiments, leverage the context-sensitivity property of ASR systems to provide preliminary entity extraction along with the word predictions via multi-task learning. Multi-task learning is a kind of training procedure in which the parameters or weights of a machine

In some embodiments, the apparatus and method described herein comprise an ASR Engine using one or more neural Networks that are trained using multi-task training methods to be able to extract simultaneously both text data and other related macro-level information, like entity data. Thus, the ASR module can be trained to account for, in parallel, sequences of words, and additional streams of information. Downstream, a named entity recognition module, is configured to receive the preliminary entity prediction data from the ASR module along with the word hypotheses and to use both simultaneously to provide an improved final entity prediction data. This has the advantage of improving and making more efficient the entity extraction step by having the NLP module using the supplemental information provided by the ASR Engine.

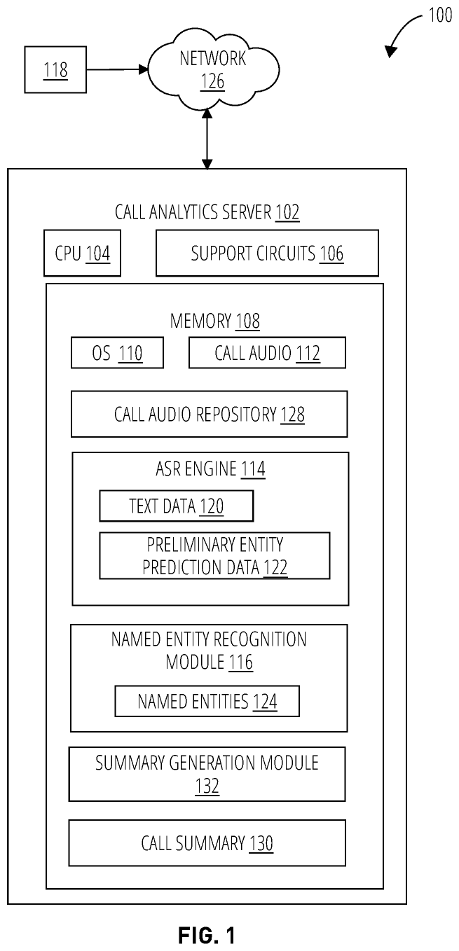

FIG. 1 is a schematic depicting an apparatus 100 for automatically generating a call summary in call center environments, in accordance with an embodiment. The apparatus 100 comprises a call audio source 118, a network 126 and a call analytics server (CAS) 102. The call audio source 118 is, for example, a call center to which a customer of a business calls, and a customer service agent representing the business.

The call audio source 118 provides the call audio 112 of a call to the CAS 102. In some embodiments, the call audio source 118 is a call center providing live or recorded audio of an ongoing call between the agent and the customer. In some embodiments, the agent interacts with a graphical user interface (GUI), which may be on a computer, smartphone, tablet or other such computing devices capable of displaying information and receiving inputs from the agent.

The CAS 102 includes a CPU 104 communicatively coupled to support circuits 106 and a memory 108. The CPU 104 may be any commercially available processor, microprocessor, microcontroller, and the like. The support circuits 106 comprise well-known circuits that provide functionality to the CPU 104, such as, a user interface, clock circuits, network communications, cache, power supplies, I/O circuits, and the like. The memory 108 is any form of digital storage used for storing data and executable software. Such memory includes, but is not limited to, random access memory, read only memory, disk storage, optical storage, and the like. The memory 108 includes computer readable instructions corresponding to an operating system (OS) 110, a call audio 112, for example, audio data of a call between a customer and an agent received from the call audio source 118, an ASR Engine 114, a named Entity recognition module 116, a call audio repository 128, a summary generation module 132 and a call summary 130. In some embodiments, the ASR Engine 114, named Entity recognition module 116 and call audio repository 128 may be located on distinct computing devices that are communicatively coupled with CAS 102.

The network 126 is a communication Network, such as any of the several communication Networks known in the art, and for example a packet data switching Network such as the Internet, a proprietary Network, a wireless GSM Network, among others. The network 126 is capable of communicating data to and from the call audio source 118, the CAS 102 and/or any other networked devices.

In some embodiments, the call audio repository 128 includes recorded audios of calls between a customer and an agent, for example, the customer and the agent received from the call audio source 118. In some embodiments, the call audio repository 128 includes training audios, such as previously recorded audios between a customer and an agent, and/or custom-made audios for training machine learning models.

In some embodiments, the ASR Engines 114 is configured to transcribe the call audio 112 from the call audio source 118 when the call is still active and generate text data of the call in real time, that is, as the parties on the call (i.e., a customer or an agent) speak or while the call is active. Unlike traditional ASR Engines, which typically only generate text data from the audio data, the ASR Engine 114 relies on one or more neural network models, for example deep neural network models, that that are specifically trained via multi-task learning training methods or techniques to generate both the text data 120 and also an associated preliminary entity prediction data 122.

Multi-task learning is a kind of training procedure in which the parameters or weights of a machine learning (ML) model are updated in a way that optimizes the performance of the ML model on multiple tasks in parallel. In some embodiments, some portions of the ML model's parameters may be task-specific, while other portions may be shared among all tasks. In the context of ASR, the ASR Engines 114 may thus be trained with multi-task training methods to predict both the text data 120 and the associated preliminary entity prediction data 122 in parallel using for example audio data from the call audio repository 128.

The text data 120 and the associated preliminary entity prediction data 122 is used by the named entity recognition module (NERM) 116 to identity one or more named entities 124 in the input call audio 112 using Natural Language Processing (NLP) methods or techniques. These may include, for example, deep, bi-directional Recursive Neural Networks (RNN) algorithms or the like. The NERM 116 identifies the intents and the entities of the call audio 112.

In some embodiments, the named entity recognition module NERM 116 recognizes entities based on one or more of machine learning (ML) based named entity recognition (NER) model, a pattern-based approach, or an intent-based approach (in which a string and a free-form entity are extracted). In some embodiments, the supporting entities include person name, organization, location, date, number, percentage, money, float, alphanumeric, email, duration, time, relationship and affirmation. In some embodiments, when entities are recognized, values associated with the entities are also identified.

In some embodiments, the CAS 102 may further comprise in the memory 108 additional modules and/or engines to extract additional information from the text data 120 generated from the ASR Engine 114, for example sentiment and/or intent. In turn, the ASR Engine 114 may be trained via multi-task training methods to generate preliminary sentiment and/or intent predictions in parallel with the text data 120, similarly to the preliminary entity prediction data 122 discussed above.

The summary generation module (SGM) 332 is used to generate a call summary 130. The SGM 132 further post-processes the results of the previous modules and/or engines to convert entities into a human readable format, for example, ‘25 dollars’ is converted to ‘$25’, ‘25 dollars and 60 cents’ to ‘$25.60’, ‘45 point 60’ to ‘45.60’, ‘50 percent’ to ‘50%’; relative dates are converted to actual dates, for example, ‘today’, ‘yesterday’, ‘next month’ or ‘last year’ and similar are converted to an actual date. The SGM 132 uses the post-processed information to generate the call summary 130 including the entities, intents, and additional information, such as the call transcript, and any other information configured therein.

The call summary 130, so generated, may then be sent for display to another device, such as a device used by the agent, to be displayed on a graphical user interface GUI or the like.

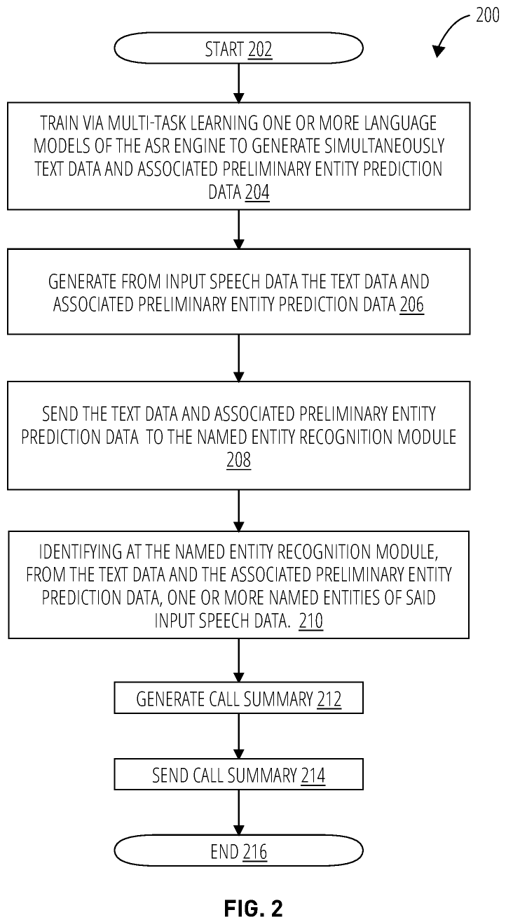

FIG. 2 illustrates a method 200 for an improved entity extraction in call center environments, performed by the apparatus 100 of FIG. 1, in accordance with an embodiment. In particular, the method 200 is performed by the call analytics server (CAS) 102. The method 200 starts at step 202 and proceeds to step 204. Step 204 is a training step, done before using the CAS 102 to process audio data in real-time. The ASR Engine is trained using multi-task training methods or techniques to simultaneously text data and associated preliminary entity prediction data. Any known multi-task training method know in the art may be used, without restriction. Training typically is done using previously recorded speech data, for example from the call audio repository 128. Once the performance of the ASR Engine 114 is satisfactory, it may be used to process input speech data in real-time. In some embodiments, this step may be done only once, and the resulting ASR Engine 114 may be reused multiple times to do steps 206 to 214 (e.g., process a call in real-time).

At steps 206 to 214, the apparatus 100 is used to process speech data in real-time, for example in the context of a customer service/call center environment or the like. At step 206, input call audio 112 is provided or fed to the ASR Engine 114 from the call audio source 118, which automatically generates therefrom the corresponding text data 120 and associated preliminary entity prediction data 122.

At step 208, the text data 120 and associated preliminary entity prediction data 122 is sent to the named Entity recognition module 116. At step 210, the named Entity recognition module 116 uses the text data 120 and the associated preliminary entity prediction data 122 to perform an improved identification the one or more named entities 124. This step is not only rendered more accurate, more efficient and less CPU intensive by the additional information provided by the associated preliminary entity prediction data 122 of the ASR Engine 114.

At step 212, the method 200 generates a call summary via the summary generation module 132, for example, the call summary 130. The call summary 130 may be sent to a user device for display on a graphical user interface (GUI) at step 214. In some embodiments, at least a portion of the call summary is sent to the user device for display on the GUI in real time, and in some embodiments, at least a portion of the call summary is sent to the user device for display on the GUI while the call is active. In some embodiments, a deliberate delay may be introduced at one or more steps, including performing the method 200 after the call is concluded, and all such variations are contemplated within the method 200.

The method 200 proceeds to step 216, at which the method 200 ends.

While audios have been described with respect to speech of conversations in a call center environment, the techniques described herein are not limited to such call audios. Those skilled in the art would readily appreciate that such techniques can be applied readily to any audio containing speech, including single party (monologue) or a multi-party speech, or a multimedia call, such as a video call.

The methods described herein may be implemented in software, hardware, or a combination thereof, in different embodiments. In addition, the order of steps in methods can be changed, and various elements may be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing platform or a “virtual machine” running on one or more computing platforms). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

I/We claim:

1. A computing apparatus for improved entity detection in a conversation, the apparatus comprising:
a processor; and
a memory storing instructions that, when executed by the processor, configure the apparatus to:
generate, at a server, from speech data of a conversation between at least two persons, text data and associated preliminary entity prediction data, using an automated speech recognition (ASR) engine comprising one or more neural networks trained via multi-task training; and
identify, at the server, using the text data and associated preliminary entity prediction data, at least one named entity in said speech data.

2. The computing apparatus of claim 1, wherein the instructions further configure the apparatus to generate a call summary comprising the at least one named entity.

3. The computing apparatus of claim 2, wherein the instructions further configure the apparatus to send the call summary or the at least one named entity for display on a device remote to the server.

4. The computing apparatus of claim 3, wherein the call summary or the at least one named entity is sent for display while the call is active.

5. A method for improved entity detection in a conversation, the method comprising:
generating, at a server, from speech data of a conversation between at least two persons, text data and associated preliminary entity prediction data, using an automated speech recognition (ASR) engine comprising one or more neural networks trained via multi-task training; and
identifying, at the server, using the text data and associated preliminary entity prediction data, at least one named entity in said speech data.

6. The method of claim 5, further comprising generating a call summary comprising the at least one named entity.

7. The method of claim 6, further comprising, sending the call summary or the at least one named entity for display on a device remote to the server.

8. The method of claim 7, wherein the call summary or the at least one named entity is sent for display while the call is active.

9. A non-transitory computer-readable storage medium, the computer-readable storage medium including instructions that when executed by a computer, cause the computer to:
generate, at a server, from speech data of a conversation between at least two persons, text data and associated preliminary entity prediction data, using an automated speech recognition (ASR) engine comprising one or more neural networks trained via multi-task training; and
identify, at the server, using the text data and associated preliminary entity prediction data, at least one named entity in said speech data.

10. The computer-readable storage medium of claim 9, wherein the instructions further configure the computer to generate a call summary comprising the at least one named entity.

11. The computer-readable storage medium of claim 10, wherein the instructions further configure the computer to send the call summary or the at least one named entity for display on a device remote to the server.

12. The computer-readable storage medium of claim 11, wherein the call summary or the at least one named entity is sent for display while the call is active.
